(19) United States
(12) Patent Application Publication
(10) Pub. No.: US 2009/0252571 A1
(43) Pub. Date: Oct. 8, 2009

(54) Expansion Dowel

(75) Inventors: Claudia Zimmerer, Lindau (DE); Franz Popp, Buchloe (DE); Erich Daigeler, Wool (DE)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 12/384,706

(22) Filed: Apr. 7, 2009

(30) Foreign Application Priority Data
Apr. 8, 2008 (DE) 10 2008 001 055.3

(51) Int. Cl. F16B 13/04

(52) U.S. Cl. 411/25

(57) ABSTRACT

An expansion dowel includes a sleeve-shaped dowel body (12) having a first dowel part (21; 61) and at least one second dowel part (31; 71) axially adjoining the first dowel part (21; 61), and at least one snap connection device (41; 81) for connecting the first (21; 61) and second (31; 71) dowel parts together and having an engagement element (42) provided on one of the first and second dowel parts (31; 71) and a receiving element (47) for the engagement element (42) and provided on another of the first and second dowel parts (21; 61).

### BACKGROUND OF THE INVENTION

1. Field of the Invention

The present invention relates to an expansion dowel including a sleeve-shaped dowel body having a first dowel part and at least one second dowel part axially adjoining the first dowel part and through which an expansion member is extandable; and at least one connection device for connecting the two dowel parts together.

2. Description of the Prior Art

For connecting different parts to constructional elements such as, e.g., walls and ceilings, an expansion dowel of the type discussed above is inserted, e.g., during through-assembly, through an opening in the to-be connected parts and into a preliminary formed bore in the constructional element. The expansion dowel is expanded with an expansion member such as, e.g., an expansion screw, in the preliminary formed bore in the constructional element in order to be anchored there. The dowel body has, at its setting direction end, a radially expandable region and a stem region adjoining the expansion region. For to-be connected parts having different thickness, the dowel bodies are produced with different lengths.

German Publication DE 199 28 633 A1 discloses an expansion dowel, having a sleeve-shaped dowel body having a first dowel part and at least one second dowel part axially adjoining the first dowel part. An expansion member is extandable through the first and second dowel parts. A plug-in connection device force-lockingly connects the two dowel parts. In assembled condition, the forcelocking connection between the two dowel parts can become loose in order to compensate for longitudinal deformation of the setting direction-side front dowel part. The dowel parts are formed of different plastic materials.

The drawback of the dowel disclosed in the above-discussed German Publication consists in that during assembly, in particular, of two dowel parts, the dowel parts can become loose from each other before insertion or during the insertion of the expansion member, and specifically, before the expansion member expands the expansion region for an adequate anchoring of the dowel in a constructional component.

Accordingly, an object of the present invention is an expansion dowel having a multi-part, sleeve-shaped dowel body and which would have improved setting characteristics.

### SUMMARY OF THE INVENTION

This and other objects of the present invention, which will become apparent hereinafter, are achieved by providing an expansion dowel the connection device of which for connecting the dowel parts of the dowel body is formed as a snap connection device having an engagement element provided on one of the two dowel parts, and a receiving element for the engagement element and provided on another of the two dowel parts.

The snap connection provides for a formlocking connection of dowel parts in the assembled condition of the dowel body which ensures a reliable mechanical connection of the dowel parts and an easy assembly of the dowel parts to form a sleeve-shaped dowel body. During assembly of the dowel parts, at least a section of a dowel part, which is connectable with another dowel part and which has corresponding elastic characteristics, expands or becomes compressed, upon assembly of the dowel parts, and the engagement element engages in the correspondingly formed recess. Independent from the shape of the expansion member and a resulting setting process, e.g., independent of whether the expansion member is set by application of blows thereto or by being rotated, the dowel parts are retained together, without being detached from each other, both in the axial direction and in the circumferential direction. The formlocking connection also prevents, e.g., rotation of the dowel part provided with the expansion region, together with the expansion screw, when it is being expanded with the expansion screw that is being screwed into the sleeve-shaped dowel body. The connection device provides only at least one snap connection or, alternatively, a combination of a plug-in connection and at least one snap connection.

Usually, the expansion region of such expansion dowels are similarly formed, in particular with regard to its length, and the shape, e.g., the stem region length is varied dependent on the necessary total length of the expansion dowel. The inventive expansion dowel permits to arbitrary combine the dowel parts. Further, the dowel parts formed of materials having different characteristics, which otherwise cannot be combined with each other, can be reliably connected with each other.

The materials for forming the dowel parts can be selected according to corresponding requirements and need not anymore be determined by the highest requirements of one of the dowel parts. The stem region has, e.g., simply a guide function for the expansion member and, therefore, can be formed of a more economical material than the expansion region which has to meet higher requirements. Because of the possibility to produce separate dowel parts independent from each other, their production is noticeably simplified, making the production of the expansion dowel more economical. This is a big advantage for mass production that such expansion dowels represent.

Advantageously, the snap connection of the dowel parts is a releasable connection, so that the inadvertently assembled dowel body can be disassembled again in its separate parts which can be re-assembled to form a new dowel body.

Advantageously, at least one of the dowel parts is formed of a plastic material, which ensures a simple and economical production of the inventive dowel. It is particular advantageous when all of the dowel parts are formed of plastic materials. The dowel parts can be formed of different plastic materials which, e.g., have different characteristics and/or chemical structure.

Because of separate production of the dowel parts, with the use of plastic materials, the flow paths and cycle times of production of the separate dowel parts are reduced during an injection-molding process, which noticeably facilitates the manufacturing process.

Advantageously, the engagement element is formed as a cam, and the receiving element is formed as a recess for receiving the cam. This ensures an easy assembly and a reliable connection of the dowel parts. The cam, e.g., is provided on the second dowel part that forms the stem region, and the receiving recess for the cam is formed on the first part having an expansion region.

Alternatively, the engagement element can be formed, e.g., as a hook or a bead extending circumferentially or only in some regions and which engages in correspondingly formed recess, dimple, or opening which serves only as receiving means.

Advantageously, in one of the dowel parts, there are provided, on its rim, which is bringable in abutment with the another of the dowel parts, at least one overlapping section projecting past the rim in an axial direction and axially overlapping, in an assembled condition of the dowel body, at least one axial region of the another of the dowel parts. This ensures a simple easy form of the snap connection device that, advantageously, is provided in the region of the overlapping section in the assembled condition of the dowel body. The wall thickness of the overlapping section is advantageously, smaller than the wall thickness in any other region of the corresponding dowel part. Therefore, the overlapping section easily expands upon assembly of the dowel parts until the engagement element engages in the receiving element of the snap connection device.

Advantageously, at least one locking element is provided on the at least one overlapping section and which engages, in the assembled condition of the dowel body, at least one counter-locking element provided on the another of the dowel parts. The locking connection ensures that the overlapping section is reliably retained, in the assembled condition of the dowel body, on another dowel part, and does not expand outwardly or inwardly during mounting of the expansion dowel. This ensures an easy mounting, without any hindrance, with one extending overlapping section.

Advantageously, the at least one locking element is formed as an engaging from-behind section, and the counter-locking element is formed as an engageable section cooperating with the engaging-from-behind section. Advantageously, the engageable section is formed complementary to the engaging-from-behind section.

Advantageously, the engaging-from-behind section and the engageable section extend in the axial direction with respect to a dowel longitudinal axis. This ensures an easy displacement of both dowel parts and their simple manufacturing, while simultaneously insuring a reliable connection of the overlapping section and the other dowel part.

Advantageously, the at least one overlapping section is mounted on the one dowel part by a hinge, which provides for a pivotal movement of the at least one overlapping section relative to the other dowel part upon displacement of the dowel part. When the snap connection device is provided in the region of the overlapping sections, a formlocking connection is formed upon the pivotal movement of the hinge-supported overlapping section.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 a side view of a first embodiment of an expansion dowel with a sleeve-shaped dowel body according to the present invention;

FIG. 2 a longitudinal cross-sectional view of the dowel body along line II-II in FIG. 1;

FIG. 3 a cross-sectional view of the dowel body along line III-III in FIG. 1; and

FIG. 4 a longitudinal cross-sectional view of a second embodiment of an expansion dowel with a sleeve-shaped dowel body according to the present invention.

### DETAILED DESCRIPTION OF THE PREFERRED EMBODIMENTS

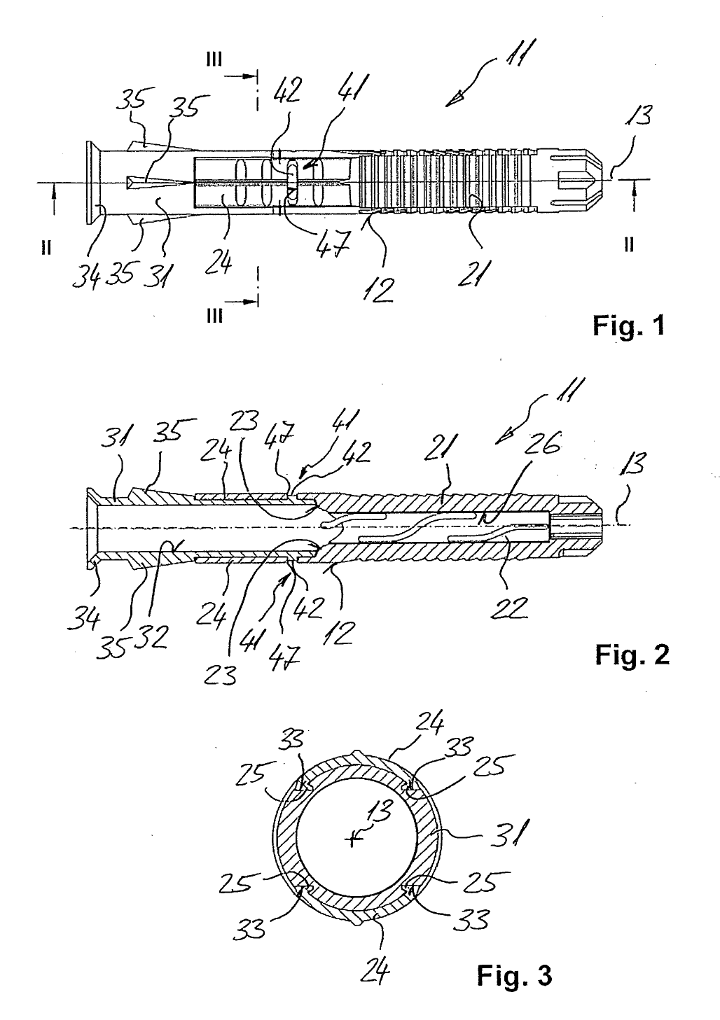

An expansion dowel 11 according to the present invention, which is shown in FIGS. 1-3, has a sleeve-shaped dowel body 12 extending along a dowel longitudinal axes 13 and having a first, front, in the setting direction, dowel part 21 with an expansion region 22, and a second dowel part 31 having a stem region 32 and axially adjoining the first dowel part 21. An expansion member, not shown, such as, e.g., an expansion screw or an expansion pin is extendable through both dowel parts 21 and 31. The two dowel parts 21 and 31 are connectable with a snap connection device 41. The first dowel part 21, which is provided with the expansion region 22, is formed of a high-grade plastic material, such as, e.g., polyamide (PA). The second dowel part 31 with a stem region 32 is formed of a plastic material having a not so high grade, such as, e.g., polyethylene (PE) or polypropylene (PP).

On the first dowel part 21, there are provided, on a rim 23 that can be brought in abutment with the second dowel part 31, two overlapping sections 24 projecting beyond the rim 23. The two overlapping sections 24 are arranged diametrically opposite each other and axially overlap, at least in some regions, the second dowel part 31 in an assembled condition of the dowel body 12. The snap connection device 41 is provided in the region of the overlapping sections 24 of the first dowel part 21. The snap connection device 41 has a radially projecting cam provided on the second dowel part 31 and forming an engagement element 42, and a recess provided on the first dowel part 21 and forming a receiving element 47. Due to elastic characteristics of both dowel parts 21 and 31, the first dowel part 21 expands, e.g., in the region of the overlapping sections 24 so that the dowel parts 21 and 31 are easily connectable with the snap connection device 41. As soon as the overlapping sections 24 find themselves in a position in which they engage from behind the engagement element 42 on the second dowel part 31, the engagement element 42 snap is in a respective recess 47, formlockingly connecting both first and second dowel part 21 and 31 with each other.

On the side edges of the overlapping sections 24, there are provided, respectively, engaging-from-behind sections likewise extending in the axial direction and forming locking elements 25. In the assembled condition of the dowel body 12, the locking elements 25 engage engageable sections provided on the second dowel part 31, likewise extending in the axial direction, and forming counter-locking elements 33.

In the embodiment shown in FIGS. 1-3, only in the first dowel part 21, there is formed an expansion hole 26 which is expandable by an expansion member, not shown. However, the expansion hole 26 can also extend into the second dowel part 31. In this case, upon driving the expansion member of the dowel, the dowel body 12 is expanded also in the region of the snap connection device 41, e.g., by the pre-assembled expansion member that is already held on the second dowel part 31, during assembly of the expansion device 11.

At the free end of the second dowel part 31, there is provided a radially projecting collar 34 that serves as a displacement limiting stop for the expansion dowel. There are further provided four, radially projecting, wedge-shaped, wing elements 35 uniformly circumferentially distributed on the outer side of the second dowel part 31. The wing elements 35 serve for preventing rotation of the set expansion dowel 11 during driving-in of the expansion member, not shown.

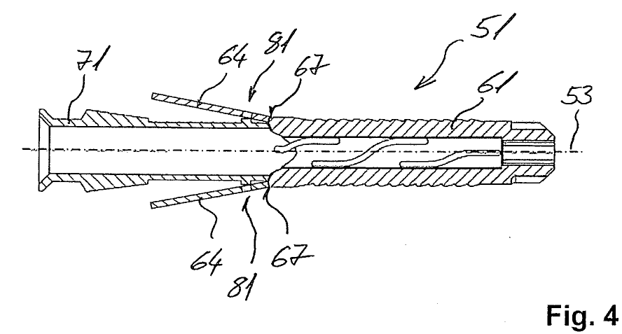

An expansion dowel 51 according to the second embodiment of the present invention (FIG. 4) in many respects is similar to the described above, expansion dowel 11. The dowel 51 differs from the dowel 11 in that the overlapping sections 64 on the first dowel part 61 are supported on the first dowel part 61 by hinges 67. Thus, upon assembly of the first dowel part 61 with the second dowel part 71, the overlapping sections 64 pivot, respectively, toward the dowel longitudinal axis 53 for locking the two dowel parts 61 and 21 together. Upon pivotal movement of the overlapping sections 64 toward the dowel longitudinal axis 63, the snap connection elements 81 snap in, insuring a formlocking connection between both dowel parts 61 and 71.

Though the present invention was shown and described with references to the preferred embodiments, such are merely illustrative of the present invention and are not to be construed as a limitation thereof and various modifications of the present invention will be apparent to those skilled in the art. It is therefore not intended that the present invention be limited to the disclosed embodiments or details thereof, and the present invention includes all variations and/or alternative embodiments within the spirit and scope of the present invention as defined by the appended claims.

What is claimed is:

1. An expansion dowel, comprising a sleeve-shaped dowel body (12) having a first dowel part (21; 61) and at least one second dowel part (31; 71) axially adjoining the first dowel part (21; 61) and through which an expansion member is extandable; and at least one snap connection device (41; 81) for connecting the first (21; 61) and second (31; 71) dowel parts together and having an engagement element (42) provided on one of the first and second dowel parts (31; 71) and a receiving element (47) for the engagement element (42) and provided on another of the first and second dowel parts (21; 61).

2. An expansion dowel according to claim 1, wherein the engagement element (42) is formed as a cam, and the receiving element (47) is formed as a recess for receiving the cam.

3. An expansion dowel according to claim 2, wherein on one of the first and second dowel parts (21; 61), there is provided, on a rim (23) thereof bringable in abutment with the another of the first and second dowel parts (31; 71), at least one overlapping section (24; 64) projecting past the rim (23) in an axial direction and axially overlapping, in an assembled condition of the dowel body (12), at least one region of the another of the first and second dowel parts (31; 71).

4. An expansion dowel according to claim 3, wherein at least one locking element (35) is provided on the at least one overlapping section (24; 64) and engaging, in the assembled condition of the dowel body (12), at least one counter-locking element (33) provided on the another of the first and second dowel parts (31; 71).

5. An expansion dowel according to claim 4, wherein the at least one locking element (25) is formed as an engaging-from-behind section, and the counter-locking element (33) is formed as an engageable section.

6. An expansion dowel according to claim 5, wherein the engaging-from-behind section and the engageable section extend in the axial direction with respect to a dowel longitudinal axis (13).

7. An expansion dowel according to claim 3, further comprising a hinge (67) for supporting the at least one overlapping section (64) on the one of first and second dowel parts (21; 61).
